(19) United States
(12) Patent Application Publication
(10) Pub. No.: US 2003/0129903 A1
(43) Pub. Date: Jul. 10, 2003

(54) FOAM APPLIED FIBERGLASS MAT COATING

(76) Inventor: PHILIPS H. MOES, Brandon, MS (US)

Correspondence Address: DONALD L COX & SCOTT R. COX, LYNCH, COX, GILMAN & MAHAN PSC, 400 WEST MARKET STREET, SUITE 2200, LOUISVILLE, KY, 40202, US

(21) Appl. No.: 09/333,448

(22) Filed: Jun. 15, 1999

(51) Int. Cl. B05D 5/00; B32B 17/02; B32B 17/04

(52) U.S. Cl. 442/180; 427/243; 427/372.2; 427/373; 442/374

(57) ABSTRACT

Disclosed herein is a process for applying a thin, continuous, foam coating to a fiberglass mat which comprises applying an emulsion polymeric coating which has been foamed to a density of about 1.5 to about 7.0 lbs./gal. and drying the coating so as to produce a thin, continuous, foam coating.

### BACKGROUND OF THE INVENTION

This invention relates to a method for applying a foam coating to a substrate. In particular, this invention relates to a method for applying a continuous film, coating to fiberglass mat which may be incorporated in or applied to a rigid base such as gypsum board, drywall, or polyisocyanate insulation board.

Fiberglass has often been embedded into or coated onto gypsum or polyisocyanate insulation board as a means to provide it with increased strength and usefulness outdoors.

However, fiberglass faced products, particularly gypsum board or drywall and isocyanate insulation board which have a layer of non-woven or woven fiberglass mat on their surfaces, suffer from a number of disadvantages, in part, due to the fact that the fiberglass surface fibers often stick out from the surface and become unnecessarily entangled in materials which come in contact with them or cause skin irritation for workers installing these products.

A wide variety of compositions for coating substrates is known in the coatings industry. The application of foam coatings has also been known for many years. However, most of the foam coatings which have been applied are either crushed or of an open cell nature. For example, U.S. Pat. No. 4,439,473 discloses an open cell breathable foam. U.S. Pat. Nos. 3,607,341, 4,326,904, 4,839,222, 4,265,965, and 5,616,419 disclose crushed foams. U.S. Pat. No. 4,326,904 discloses a heat collapsible foam as does U.S. Pat. No. 4,839,222. In addition, foamable blister coatings such as those disclosed in U.S. Pat. No. 4,241,125 have also been disclosed as have penetrating coatings as disclosed in U.S. Pat. No. 4,372,900.

The application of foams to different substrates such as wood, U.S. Pat. No. 5,616,419 and U.S. Pat. No. 5,635,248 or leather, as in U.S. Pat. No. 3,919,451, is also known.

U.S. Pat. No. 5,112,678 discloses a coating composition applied to a glass fiber porous webbed substrate while U.S. Pat. No. 4,677,016 discloses the application of a foam coating to fiberglass fabrics.

U.S. Pat. No. 3,640,916 discloses certain foamed coatings useful as insulators, soundproofing materials, packaging materials, cushioning materials, floor and wall coverings, and as decorative items which are prepared using volatile organic liquids. No disclosure is made of the use of these materials as coatings for fiberglass faced boarding.

Accordingly, it is an object of this invention to prepare a continuous coating for fiberglass mats, in general, and, specifically, fiberglass mats which are embedded in or applied to a wide variety of rigid substrates, including dry wall, gypsum board, or polyisocyanate insulation.

It is another object of this invention to prepare a coating which prevents glass fibers from becoming entangled or engaged in other products.

It is another object of this invention to prevent fiberglass fibers from loosening from the surface of the fiberglass mat and becoming airborne or becoming embedded in the skin of workers who handle these products.

It is another object of this invention to prepare a coating which prevents liquids, particularly gypsum slurry and liquid polyisocyanate from penetrating the fiberglass mat.

It is a further object of this invention to provide a coating which acts as a barrier to liquid water when the rigid substrates of the instant invention are put into service as sheathing for buildings.

It is a further object of this invention to prepare coatings which allow the passage of water vapor.

It is another object of this invention to prepare a coating composition which may be used to significantly reduce or eliminate the defects previously observed with fiberglass embedded products such as gypsum or drywall.

It is another object of this invention to apply a relatively thick film of foam with low film weight so as to lower the cost of the coating.

These and other objectives are obtained by the instant invention.

### SUMMARY OF INVENTION

The instant invention is directed to a process and product for preparing thick coatings with low film weight on a fiberglass mat which involves preparing a foam of a polymeric latex coating composition, applying that composition to the surface of the fiberglass substrate and drying the coating to produce a continuous film.

### DETAILED DESCRIPTION OF INVENTION

The fiberglass mats used in the instant invention are preferably non-woven in character although woven mats may also be used. Also included in the instant invention are mats wherein the fibers are both randomly distributed and distributed in a pattern configuration. The non-woven mats are often referred to as “chopped strand” mats. They may have a wide variety of thicknesses ranging from about 15 mils to about 40 mils and may be applied on a variety of substrates, including particularly gypsum board or dry wall.

They are applied to gypsum board or drywall in order to provide greater strength and resistance to moisture, so as to allow its use out of doors. The fiberglass itself is applied to the gypsum board normally in its wet state and the embedded product is allowed to dry therein. See, for example, U.S. Pat. No. 5,883,024.

In addition to drywall or gypsum board, the fiberglass mats of the instant invention may be applied to or embedded in any form of rigid substrate. Another particularly preferred substrate is polyisocyanate insulation board.

The coating compositions of the instant invention may be applied to the fiberglass mat either before or after it is embedded in or attached to the rigid surfaces of the instant invention.

Following application of the fiberglass mat to the desired rigid substrate, the product exhibits a rough textured finish wherein the fiberglass fibers stick out from the surface. In normal use these products are difficult to handle because of their rough, uneven finish. In addition, because of the presence of the fiberglass fibers on the surface, articles of clothing or other materials tend to become snagged or caught on the surface of the uncoated fiberglass imbedded gypsum board. In addition, gypsum board with fiberglass mat coatings often causes itching of the skin and irritation when boards are handled and transported to the job site and installed.

The polymeric lattices of the instant invention may be formed from a wide variety of products including the polyvinyl alcohol, polyvinyl acetate, acrylic emulsions, polyvinyladene chloride ethylene/vinyl chloride emulsions and other types of emulsion materials. Of particular importance are copolymers of at least one ethylinically unsaturated monomer, such as, for example, acrylic ester monomers including methyl acrylate, ethyl acrylate, butyl acrylate, 2-ethylhexyl acrylate, decyl acrylate, methyl methacrylate, butyl methacrylate, lauryl(meth)acrylate, isobornyl(meth)acrylate, isodecyl(meth)acrylate, oleyl(meth)acrylate, palmityl(meth)acrylate, stearyl(meth)acrylate, hydroxymethyl(meth)acrylate, hydroxyethyl(meth)acrylate, and hydroxypropyl(meth)acrylate; acrylamide or substituted acrylamides; styrene or substituted styrenes; butadiene; vinyl acetate or other vinyl esters; vinyl monomers, such as, for example, vinyl chloride, vinylidene chloride, N-vinyl pyrrolidone; amino monomers, such as, for example, N,N¹-dimethylamino(meth)acrylate; and acrylonitrile or methacrylonitrile. Additionally copolymerizable ethylenically-unsaturated acid monomers, such as, for example, from 0.1 percent to 7 percent, by weight based on the weight of the emulsion-polymerized polymer, acrylic acid, methacrylic acid, crotonic acid, itaconic acid; fumaric acid, maleic acid, monomethyl itaconate, monomethyl fumarate, monobutyl fumarate, maleic anhydride, 2-acrylamido-2-methyl-1 propanesulfonic acid, sodium vinyl sulfonate, and phosphoethyl methacrylate, may be used.

The polymer used in this invention can be a substantially thermoplastic or substantially uncrosslinked polymer when applied to the substrate. If desired, premature crosslinking or gelling of the polymer is induced by adding to the monomer mix multi-ethylenically unsaturated monomers in the range of 0.01% to 5%, by weight based on the weight of the polymer. Typical multi-ethylenically unsaturated monomers include allyl methacrylate, trimethylolpropane triacrylate, diallyl phthalate, 1,4-butylene glycol dimethacrylate, 1,6-hexanedioldiacrylate and divinyl benzene. It is important, however, that the quality of the film formation is not materially impaired.

Depending upon the intended use of the coating, additional components may be added to the polymerized latex emulsion. These additional components include but are not limited to pigments; pigment extenders; plasticizers; cosolvents; rheology modifiers; fillers, such as, talc; preservatives and freeze/thaw protectors. More particularly preferred filler is clay in platelet form.

The polymeric latex of the instant invention may be compounded with about 1-15 percent, preferably 5-10 percent by weight based on the polymer solids content of a foaming agent. Some of the suitable foaming agents include alkali metal, ammonium and amine salts of fatty acids, such as, aliphatic or mixtures of aliphatic and aliphatic carboxylic acids, or the mixtures thereof. Examples of preferred aliphatic carboxylic acids include stearic acid, tallow fatty acids and oleic acid. Particularly preferred are salts or soaps of stearic acid or of partially or fully hydrogenated tallow acid, hydrogenated tall oil fatty acids, hydrogenated soy bean oil fatty acids, and hydrogenated tung acids. More preferred water-soluble salts or soaps of these acids are the alkali metal, usually sodium or potassium salts, the ammonium salts and the amine salts, such as, alkanolamine salts, e.g., mono-, di- and triethanolamine salts. Ammonium stearate is most preferred.

The polymerized latex emulsion further contains from 0 to 15 percent, preferably from 0.1 to 15 percent, more preferably 5 to 7 percent, by weight of the emulsion solids of a foam stabilizer. Suitable foam stabilizers include anionic and nonionic surfactants, such as, sulfosuccinate ester salts, such as, disodium N-octadecylsulfosuccinate, tetrasodium N-(1,2-dicarboxyethyl)-N-octadecylsulfosuccinate, sulfosuccinimate surfactant diamyl ester of sodium sulfosuccinic acid, dihexyl ester of sodium sulfosuccinic acid, dioctyl ester of sodium sulfosuccinic acid. Additional foam stabilizers include cationic or an amphoteric surfactants, such as, distearyl pyridinium chloride, N-coco-beta-aminopropionic acid or the sodium salts thereof. Calcium succinimate is preferred.

The foamed coatings of the instant invention are foamed by a variety of methods, including the use of air or gas whipping action, using gases such as carbon dioxide and nitrogen or air, or by utilizing a high velocity agitator such as a Kitchen Aid mixer, a Waring blender or other similar apparatus.

The finished coating of the instant invention has a density significantly less than the density of water. Preferably the weight per gallon of the foam coating in the instant invention ranges from about 1.5 pounds up to about 6 pounds, preferably about 1.5 to about 4 pounds per gallon. More dense coatings are not necessary for practice of the instant invention and, in fact, unduly increase the cost of the resulting product without any significant improvement in the performance of the product.

Once the foamed polymer coating is prepared it is advantageous to immediately proceed with applying the polymer coating to the desired substrate so that the amount of foaming does not significantly diminish. A coating may be applied by any one of a variety of methods, including spraying, roller coating, curtain coating, flow coating, or by extrusion. A particularly preferred method of application of the film involves using a parabolic foam applicator manufactured by Gaston Systems Inc. The extrusion method of coating is the preferred method if the foam is to be applied to gypsum board during or after manufacture. Regardless of the method for application, the foam coating is leveled to the desired thickness by a conventional means such as a doctor blade. Preferably the layer will be in the range of about 5 to about 50 mils, preferably about 10 to about 40 mils.

Once the coating is applied, it is allowed to dry depending on available conditions from several hours at room temperature to more preferably at elevated temperatures above 150° F., preferably from 200° F. to about 600° F. for time periods of a few seconds to a few minutes depending upon the temperature employed.

The resulting coated product exhibits good feel and a smooth surface. In addition, by encapsulating the fiberglass fibers, the products of the instant invention do not exhibit the rough, uneven surfaces which uncoated fiberglass/gypsum board exhibits. Additionally, because of the coatings of the instant invention, the fiberglass fibers do not have a tendency to become entangled as do uncoated fiberglass mats. Further, the coating of the instant invention prevents liquids such as gypsum slurry or isocyanate filling materials from penetrating the fiberglass mat. At the same time, the coated products of the instant invention act as a barrier to liquid water, particularly when the products of the instant invention are put into service as sheathing for buildings, while at the same time allowing for water vapor to pass through.

A key advantage to the coatings of the instant invention is that by employing these coatings, a thin film relative to normal coatings for fiberglass may be applied which has an extremely low film weight, thereby lowering the cost of the coating. Typically the foamed coatings of the instant invention have densities in the range of about 1.5 to about 7.0 lbs/gal., preferably about 2.5 to about 3.5 lbs./gal.

In some applications, it is desirable to apply more than one layer of the coating of the instant invention.

### EXAMPLE 1

A coating composition was prepared by mixing 22.8 parts of water, 0.4 parts of 28-30 weight percent ammonium hydroxide in water, 1.14 parts of Taymol 731, a solution dispersant provided at the 25 percent by weight level in water, 0.2 parts of Surfynol TG, an acetylenic diol surfactant available from Air Products and Chemicals, Inc., 47.4 parts of ASP 400 clay, an inert pigment, 27.6 parts of Rhoplex B959, an acrylic emulsion available from the Rohm and Haas Corporation at 55 percent by weight solids in water, and 0.5 parts of Acrysol ASE 60, an alkaline soluble acrylic thickening agent available from Rohm & Haas.

200 parts of the above mixture were mixed with 7 parts of Stanflex 320, an ammonium stearate soap, and vigorously agitated at high speed using a Kitchen Aid mixer for approximately 5 minutes. The resulting foamed product had a density of approximately 2.5 pounds per gallon.

A sample of this product was applied to a fiberglass mat using an adjustable doctor blade set to prepare a foam coating thickness of 10 mils. The applied foam coating composition was then dried for approximately three minutes in an oven set at 325° F. resulting in a coating composition which exhibited a continuous closed cell film.

The coated product was readily useable by workmen without any of the skin irritant effects demonstrated by prior art uncoated products. There were no pinholes in the film and the surface had a smooth silky feel. The coated mat could be folded to a 90 degree angle without cracking of the film. When liquid polyisocyanate was poured onto the fiberglass mat from the side opposite of the coating, no bleed-through occurred.

### EXAMPLE 2

Example 1 was repeated except that 1% by weight based on latex solids of Triton X405, an octyl phenoxypolyethoxyethanol surfactant was added along with 2% by weight based on latex solids of Cymel 303, a polyhexamethoxymethylol melamine available from American Cyanamid Co.

200 parts of the above mixture were blended with 7 parts of Stanflex 320, an ammonium stearate soap, and processed through an ET Oaks Corporation foam generator. The resulting foam exhibited small stable bubbles and a density of 3.0 pounds per gallon.

A sample of this foam was applied to fiberglass mat at a thickness of 10 mils and dried at 325° F. for 3 minutes. The resulting product was similar in properties to the product prepared by Example 1, except that the foam bubbles were smaller and more uniform in size and the film was tougher due to crosslinking.

### EXAMPLE 3

Using the same procedure as in Example 1, a coating composition was prepared based upon a latex having the following

| % Weight | Description |
|---|---|
| 17.03 | Tap water |
| 0.83 | Ammonium Hydroxide 20-30% Sol. |
| 0.62 | Tamol 731A Dispersant |
| 0.21 | Surfynol TG Surfactant |
| 29.10 | ASP 400 Clay |
| 52.04 | Rhoplex B-959 Emulsion |
| 0.17 | Acysol ASE-60 Rheology Modifier |

The resulting product, when mixed in the same ratio with Stanflex 320 and applied to fiberglass mat as described in Example 1, produced a somewhat tougher dried film.

### EXAMPLE 4

Example 1 was repeated with the following latex composition:

| % Weight | Description |
|---|---|
| 26.80 | Tap water |
| 0.52 | N, N Dimethylethanolamine |
| 0.89 | Tamel 731A Dispersant |
| 0.21 | Surfynol TG Surfactant |
| 41.80 | ASP 400 Clay |
| 27.34 | E-3595 Hydroxyl functional acrylic |
| | latex from Rohm & Haas |
| | (45% solids) |
| 1.29 | Polymeric Melamine |
| | (85% solids in water) |
| 1.14 | Acysol ASE60 Rheology Modifier |

After mixing with Stanflex 320 and drying as specified in Example 1, the resulting product produced a foam which was identical to the foam of Example 1. The dried film was somewhat harder, however.

The above examples are merely exemplary of the instant invention. Changes may be made in the examples and the specification without departing from the scope and/or spirit of the invention.

What is claimed is:

1. A process for applying a continuous, substantially solvent free, foam coating to a fiberglass mat which is attached to or embedded in a rigid substrate which comprises applying an emulsion polymeric coating which has been foamed to a density of about 1.5 to about 7.0 lbs./gal. and drying the coating so as to produce a film thereon.

2. A process for applying a continuous, substantially solvent free, foam coating to a fiberglass mat which is embedded in gypsum board which comprises applying an emulsion polymeric coating which has been foamed to a density of about 1.5 to about 7.0 lbs./gal. and drying the coating so as to produce a film thereon.

3. A process for applying a continuous, substantially solvent free, foam coating to a fiberglass mat which is embedded in or attached to polyisocyanate insulation board which comprises applying an emulsion polymeric coating which has been foamed to a density of about 1.5 to about 7.0 lbs./gal. and drying the coating so as to produce a film thereon.

4. The process of claim 1 wherein the drying is conducted at a temperature of above 150° F.

5. The process of claim 1 wherein the drying is conducted at a temperature of about 200° F. to about 600° F.

6. The process of claim 1 wherein the thickness upon initial application of the coating prior to drying is in the range of 5 to 50 mils.

7. The process of claims 1, 2 or 3 wherein the thickness upon initial application is in the range of 10 to 40 mils.

8. The process of claims 1, 2 or 3 wherein the dried coating has a thickness in the range of about 0.5 to about 4.0 mils.

9. The process of claims 1, 2 or 3 wherein the coating composition is formulated with about 1 to about 15 percent by weight based on emulsion solids of a foaming agent.

10. The process of claim 1 wherein the coating composition is formulated with about 5 to about 10 percent by weight of a foaming agent.

11. The process of claim 9 wherein the foaming agent is an alkali metal, ammonium, or fatty amine salt, of a fatty acid.

12. The process of claim 1 wherein the coating composition is formulated with about 0.1 to about 15 percent by weight based on emulsion solids of a foam stabilizer.

13. The process of claim 1 wherein the coating is foamed utilizing air whipping.

14. The process of claim 1, 2 or 3 wherein the coating is foamed using high speed agitation.

15. The process of claim 1 wherein the coating is applied utilizing a doctor blade.

16. An article comprising a first layer of a rigid substrate, a second layer embedded in or attached to said first layer, of a fiberglass mat, and a third layer of a continuous, substantially solvent-free foam coating composition.

17. An article comprising a first layer of a gypsum board, a second layer embedded in or attached to said first layer of a fiberglass mat, and a third layer of a continuous, substantially solvent-free foam coating composition.

18. An article comprising a first layer of polyisocyanate insulation board, a second layer embedded in or attached to said first layer of a fiberglass mat, and a third layer of a continuous, substantially solvent-free foam coating composition.

19. The article of claim 16 wherein the fiberglass mat is random in nature.

20. The process of claims 1, 2 or 3 or the article of claims 16, 17, and 18 wherein the coating composition is a polymeric latex based, at least in part, upon acrylate monomers.
